(19) United States
(12) Patent Application Publication
(10) Pub. No.: US 2025/0018372 A1
(43) Pub. Date: Jan. 16, 2025

(54) METHOD FOR PREPARING NANOMATERIAL MACROSCOPIC COMPOSITESTHROUGH SUBSTRATE HEATING AND SOLVENT EVAPORATION

(71) Applicant: ZHEJIANG UNIVERSITY, Zhejiang (CN)

(72) Inventors: Yingchun FU, Zhejiang (CN); Lin ZHANG, Zhejiang (CN); Yingjun LIU, Zhejiang (CN); Chao GAO, Zhejiang (CN); Yibin YING, Zhejiang (CN)

(73) Assignee: ZHEJIANG UNIVERSITY, Zhejiang (CN)

(21) Appl. No.: 18/280,479

(22) PCT Filed: Apr. 8, 2022
(86) PCT No.: PCT/CN2022/085904

§ 371 Date: Sep. 6, 2023

(30) Foreign Application Priority Data
Mar. 30, 2022 (CN) 202210331670.6

(51) Int. Cl. B01J 20/30; B01J 20/02; B01J 20/22; B82Y 30/00

(52) U.S. Cl. CPC B01J 20/3078; B01J 20/02; B01J 20/22; B82Y 30/00; B01J 2220/4806; B01J 2220/4812

(57) ABSTRACT

A method for preparing nanomaterial macroscopic composites through substrate heating and solvent evaporation is provided, and the method includes setting a substrate, and preparing a reaction precursor solution required for the synthesis of nanomaterials; evenly dropping a small volume of the precursor solution on/in the substrate; performing a heating method to make the substrate generate a heat and transferring the heat to the precursor solution on/in the substrate; after a period of time, terminating the heating of the substrate to finish the synthesis, removing and cleaning the substrate, thus obtaining corresponding nanomaterial macroscopic composites.

### TECHNICAL FIELD

The present disclosure relates to a new method for preparing nanomaterial macroscopic composites, and specifically relates to a technical method for synergistically accelerating the nucleation and growth of nanomaterials on macroscopic assemblies by utilizing a localized heat generated through substrate heating and solvent-evaporation-caused concentration. The disclosure belongs to the technical field of preparation of inorganic and inorganic-organic hybrids.

### DESCRIPTION OF RELATED ART

Because of the physical and chemical properties of nanomaterials, such as large specific surface area, high surface energy, and abundant optical, electrical, magnetic, and thermal properties, nanomaterials have exhibit good application potential in many fields such as energy storage and conversion, gas separation, catalysis, and sensing. However, most nanomaterials are present in the form of fine powders, which is not only inconvenient for actual operation (difficult to weigh, disperse, recycle, etc.), but also limits the full development of excellent performance of nanomaterials in the application. Therefore, integrating nanomaterials on the surface/inside of various substrates to make composites that are easy to operate macroscopically (defined as nanomaterial macroscopic composites, referred to as composites, such as fibers, films, aerogels, etc.) carries far-reaching academic significance and great application value.

The strategies of integrating nanomaterials may be divided into two categories: pre-preparation-mixing-embedding and in-situ growth. Specifically, in-situ growth method has been widely studied and adopted due to its characteristics of simple and direct operation, high activity of the produced nanomaterials. In order to improve the preparation efficiency and enhance the loading capacity and stability of nanomaterials in the composite, a lot of researches have been carried out to promote the nucleation and growth of nanomaterials on substrates through pretreatment/modification of substrates and external energy supply. At present, substrate pretreatment methods mainly include activation (such as acidification, calcination, electrochemistry), loading linkers (such as dopamine, proteins, cellulose) and deposition of metal sources (such as electron beam evaporation, chemical growth), etc. In the methods mentioned above, the binding sites of nanomaterials on the substrate are enriched to promote the nucleation and growth, thus significantly increasing the loading capacity of nanomaterials. However, most steps are tedious and complicated, which increases the time and energy consumption of the preparation of the composite. On the other hand, due to the strict synthesis conditions, high reaction energy barrier and difficulty in achieving nucleation and growth of nanomaterials, many technologies such as hydrothermal/solvothermal synthesis, microwave, ultrasonic, evaporation, etc. have been introduced to supply energy to promote the nucleation and growth of nanomaterials.

These technologies improve the preparation efficiency of composites from different aspects, but most of them need to utilize large-scale equipment and strictly controlled reaction conditions, such as high temperature, high pressure, sealing, etc. In the meantime, since the energy applied by most methods is transferred from the reaction solution to the substrate, unexpected homogeneous nucleation of nanomaterials would occur in the solution. As a result, not only a lot of energy and raw materials are consumed, but also a competitive relationship is established to compete with nucleation and growth of nanomaterials on the substrate, and therefore the method can hardly improve the preparation efficiency of the composites.

In summary, preparing composites by the in-situ method is restricted by some disadvantages because this method requires many steps, takes a lot of time, has low utilization rate of raw materials and energy consumption as well as strict reaction conditions, imposes high requirements for equipment, and high cost, which are unfavorable for large-scale industrial production and application. Therefore, how to realize simple and efficient preparation of the composites is widely studied and difficult to be solved in the field.

### SUMMARY

The purpose of the present disclosure is to provide a simple and efficient preparation method of composite to solve the problem that the powder state of nanomaterials limits its practical application.

The technical solution that the present disclosure adopts and concrete preparation steps are as follows:

1) Pre-preparation: The substrate was cut into a specific size as required, the substrate was settled, and the reaction precursor solution required for the synthesis of nanomaterials was prepared.

2) A small volume of precursor solution was evenly dropped on/in the substrate. The small volume of precursor solution in step 2) is on the order of microliters, specifically 1-10 microliters, which is two orders of magnitude lower than the related art.

3) A certain heating method was performed to make the substrate generate heat and transfer heat to the precursor solution on/in the substrate. After a period of time, heating of substrate was terminated to finish the synthesis, the substrate was removed and then fully cleaned, then dried and activated to obtain the corresponding composites.

On the one hand, the heat generated by the present disclosure will induce and promote the nucleation and growth of nanomaterials on the surface of the substrate and its vicinity; on the other hand, the heat also accelerates the rapid ramping and evaporation of a small amount of solvent on the surface of the substrate, resulting in the reduction of the solvent volume and the concentration of the precursor, which further accelerates the nucleation and growth of more nanomaterials with the synergy of the localized heat.

The types of materials for the substrate include but are not limited to carbon materials (carbon black, graphene, carbon nanotubes), two-dimensional transition metal chalcogenides, metals (gold, nickel), metal oxides, and the like.

The form of materials of the substrate adopts materials that can directly or indirectly generate heat or conduct heat, including but not limited to one-dimensional fibers, two-dimensional films and cloths, three-dimensional sponges and foams, and the like.

In the step 3), the heating method of the substrate includes all the methods that can quickly increase the temperature of the substrate material, including electrothermal, photothermal, microwave heating and other methods in which the substrate itself directly generates Joule heat, and also includes placing the substrate on the surface of the heating table for heat transfer and other indirect heating methods.

The main components of the reaction precursor solution include reaction raw material A, solvent B and growth regulator C, and A and C are fully dissolved in solvent B, and reaction raw material A, solvent B and growth regulator C are mixed uniformly.

In the reaction precursor solution, the concentration of the reaction raw material A is 0.1-200 mM, and the reaction raw material A includes but not limited to inorganic metal ions and organics.

The inorganic metal ions include Cu²⁺, Zn²⁺, Co²⁺, Fe³⁺, Tb³⁺, Eu³⁺, Zr⁴⁺ and the like.

The organics include trimesic acid, terephthalic acid, 2-aminoterephthalic acid, 2-methylimidazole, fumaric acid, and the like.

In the reaction precursor solution, the solvent B includes, but is not limited to, a mixture of one or more of water, ethanol (EtOH) or N,N-dimethylformamide (DMF).

The reaction precursor solution also includes a growth regulator C, which is added according to the requirement of the synthesis reaction, and the types of the growth regulator C include but are not limited to ethylenediamine, triethylamine or polyvinylpyrrolidone.

In the reaction precursor solution, the volume fraction of the growth regulator C is 0.1-10%.

The types of nanomaterials in the composites include, but are not limited to, all materials prepared by solvothermal methods, such as metal organic frameworks (MOFs), covalent organic frameworks (COFs), metals and their oxides. Metal-organic frameworks (MOFs) include HKUST-1 (CuBTC), ZIF-8, ZnBDC, MIL-88A, MIL-88B, TbBTC, EuBTC or UiO-66, etc.

The component of the composite is a single component, or multiple components such as binary or ternary, and the components are determined depending on the types of reaction raw materials in the reaction precursor solution.

The composites obtained in the present disclosure includes all possibilities of various arrangements and combinations of the above-mentioned types of substrates and types of nanomaterials.

The present disclosure prepares and obtains the composite through a specific preparation method, and only a very small amount of raw materials needs to be added in a very short time to achieve a product result with excellent performance, thereby realizing efficient preparation.

When the reaction raw material A is an inorganic metal ion, the concentration of the reaction raw material A is 0.1-200 mM, and the solvent B is water or an organic solvent.

When the substrate is a heat-generating material, the heat-generating methods include electric heating, microwave heating, photothermal and other stimuli-heating operations, and the duration time for applying the stimulus is taken as the reaction time.

When the substrate is a heat-conducting material, the heating method is placing the substrate on a heater.

In step 3), the volume of the precursor solution on the two-dimensional planar substrate is 5-15 μL cm⁻²; on the three-dimensional sponge substrate, the volume of the precursor solution is 1-1.65 μL mm⁻³.

The volume of the precursor solution is adjusted according to the liquid volume that the substrate is able to accommodate, the viscosity of the precursor, and the affinity between the precursor and the substrate. It is advisable that the precursor exactly covers the reaction part.

In the step 3), the heating temperature is of 60-300° C., and the temperature of the substrate is lower than the thermal decomposition temperature of the nanomaterial as a reference. The reaction time was 0.01-15s; the cleaning solvent was water, EtOH, acetone or water-ethanol-DMF; the drying temperature was 60-150° C., and the drying time was 6-24 hours.

The composite is applied in various aspects including but not limited to water purification, gas separation, catalysis, and sensing.

The present disclosure regulates the local heat generated on the surface/inside of the substrate, synchronously combines the evaporation-caused concentration effect of a small volume of precursor on the surface of the substrate, synergistically induces and promotes the rapid nucleation and growth of nanomaterials, and finally obtains a composite with complete structure and high quality. Compared with related art, the advantages of the present disclosure are as follows:

1) By synergistically promoting the nucleation and growth of nanomaterials on the substrate through the “substrate heating-evaporation concentration” effect, it is possible to considerably improve the fabrication efficiency of the composite. Energy consumption is low, reaction time is shortened to seconds or sub-seconds, and the minimum concentration of raw materials may be reduced to the order of micromoles per liter.

2) The preparation steps are simple, the operation is easy, and the requirements for the instrument and the environment are low. Only the power supply is needed to control the heating of the substrate, and the operation may be carried out under a normal temperature, normal pressure, and in an atmospheric environment.

3) The growth process, structure, morphology, and position distribution of nanomaterials on the substrate may be regulated by controlling the heating of the substrate.

4) In the obtained composite, the structure and physical and chemical properties of the substrate are well preserved, and the nanomaterials on the substrate are of high quality with the characteristics of continuity, uniformity, and large specific surface area, and exhibit excellent performance as effective adsorbents in the field of water purification.

### BRIEF DESCRIPTION OF THE DRAWINGS

FIG. 1 is the scanning electron micrograph of a graphene film (GF, A) and a product HKUST-1/GF-1 (B) in Example 1.

FIG. 2 is an X-ray powder diffraction pattern (XRD, (A)) of HKUST-1/GF-1 in Example 1 as well as the digital photographs of methylene blue (MB) solution before and after adsorption by HKUST-1/GF-1 and the corresponding UV-Vis absorption spectra (B).

FIG. 3 is a scanning electron micrograph of the product HKUST-1/GF prepared by other conventional methods under the same precursor concentration conditions as in Example 1. The reaction conditions in each figure are as follows: A-room temperature control group 400 μL precursor, 25° C. reaction (A1: reaction time is 1 min, A2: reaction time is 10 min), B-solvothermal group 400 μL precursor, 120° C. reaction (B1: reaction time 1 min, B2: reaction time is 10 min).

FIG. 4 is a scanning electron micrograph of a product HKUST-1/GF-2 in Example 2.

FIG. 5 is a scanning electron micrograph of a product HKUST-1/GF-3 in Example 3.

FIG. 6 is a scanning electron micrograph of a product MIL-88A/GF in Example 4.

### DESCRIPTION OF THE EMBODIMENTS

In order to enable those skilled in the art to better understand the technical solution of the present disclosure, the method provided by the present disclosure will be described in detail below in conjunction with the accompanying drawings and embodiments. The following examples are only used to illustrate the present disclosure but not to limit the scope of the present disclosure.

Embodiments of the present disclosure are as follows:

### Example 1 HKUST-1/GF-1

HKUST-1/GF-1 was prepared by using electrothermal method to generate local Joule heat in GF. The specific preparation method is as follows.

GF was washed, dried and cut into a size of 2 mm×2.25 cm. A synthesis reaction device was established. GF was placed horizontally and suspended in the air, a 1 cm-wide reaction area was retained in the middle for dripping reaction precursor solution, both ends were fixed and connected to copper foil through silver glue, and the foils were connected to the positive and negative ends of the power supply, respectively. 255 mM Cu(NO₃)₂ (dissolved in H₂O), 165 mM trimesic acid (dissolved in DMF) and EtOH were mixed in equal volumes to prepare a precursor solution. 2.35 μL of the precursor were taken and evenly drop-coated in the reaction area of GF. Programming was performed to make the power supply apply a 3 A of current to the GF coated with the precursor, so that the temperature of the GF was increased to about 300° C., and the reaction time was 0.95 s. After supplying, the film was removed and the reaction zone was kept, the film was washed thoroughly with DMF (1 time) and EtOH (2 times), and dried in an oven at 80° C. to obtain HKUST-1/GF-1.

The characterization results are as follows.

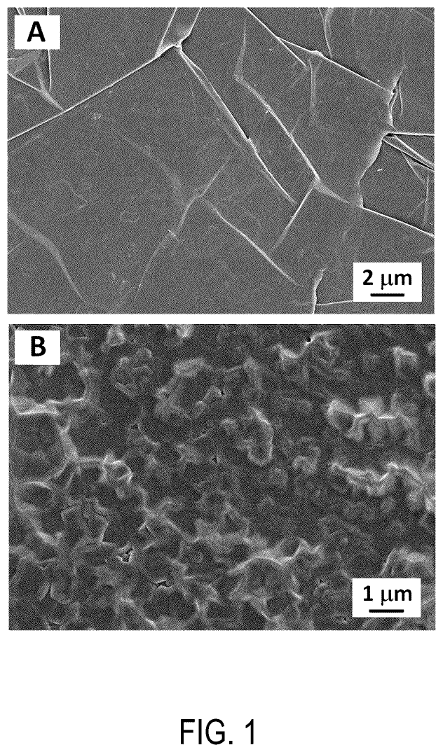

The structure and morphology of HKUST-1/GF-1 prepared in Example 1 were characterized by field emission scanning electron microscopy. Before the synthesis, the substrate GF was composed of a large number of tightly stacked graphene sheets, as shown in FIG. 1-A, the substrate surface was relatively smooth, and there were many distributed micro-wrinkles.

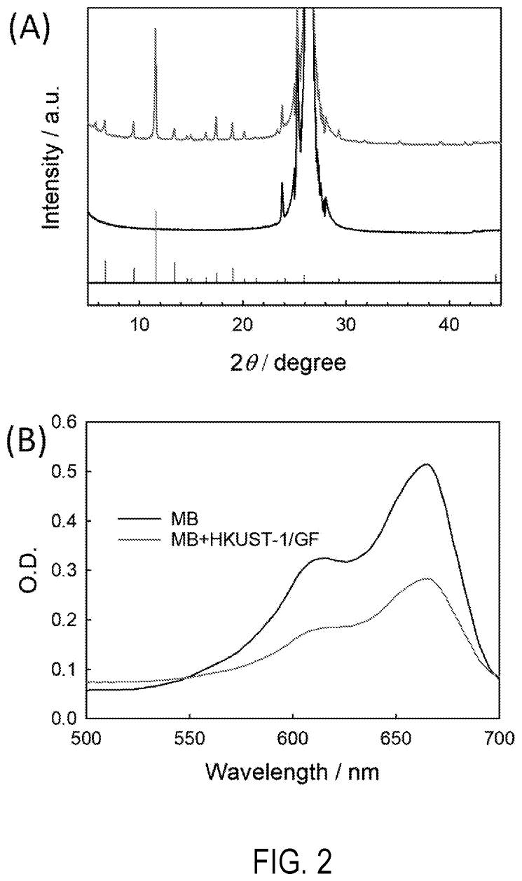

After the reaction, a flat, uniform, and dense film appeared on the GF, and the crystals in the film were intergrown (see FIG. 1-B). The phase composition of GF and HKUST-1/GF-1 was further analyzed by XRD, and the results were shown in (A) of FIG. 2. GF had an obvious characteristic peak at 26.43°, which correspondeds to the (002) plane of graphene. In HKUST-1/GF-1 sample, in addition to the characteristic peak of graphene at 26.43°, there were many characteristic peaks at places where 20 was 5.45°, 6.71°, 9.45°, 11.58°, 13.46°, 14.28°, 14.61°, 16.49°, 17.40°, 18.93° and 20.20°, which respectively correspond to (111), (200), (220), (222), (400), (331), (420), (422), (511), (440) and (620) crystal faces of HKUST-1. In the meantime, there were no characteristic peaks of common impurity Cu₂O at places where 20 was 36.4°, 42.3° and 43.3°. The result proves that the nucleation and growth of high-purity HKUST-1 is realized on the surface of GF, and the reaction time is only 0.95 s. Compared with conventional methods, the reaction time is reduced by at least 4 orders of magnitude.

The verification of application performance of this embodiment 1 is as follows.

The obtained HKUST-1/GF-1 was used for MB adsorption to evaluate the quality of HKUST-1 and its application performance for water purification. As shown in (B) of FIG. 2, after soaking with HKUST-1/GF-1, the MB solution changed from blue to light blue. Calculation was performed through O.D. decrease ratio and proportion of HKUST-1 content, the saturated adsorption capacity of MB adsorbed by HKUST-1 in HKUST-1/GF-1 was 365 mg g⁻¹, which was higher than the corresponding value of HKUST-1 coating or even free HKUST-1 particles reported in most literatures. In light of the above, it is proven that the method of the disclosure not only has high preparation efficiency, but also has good product quality with excellent performance and prospects in the application field of water purification (adsorption of dyes), simultaneously realizing extremely efficient preparation and excellent performance.

In comparison with other preparation methods, the comparative results are as follows.

In order to compare the difference between this method and the conventional preparation method, especially the difference in preparation efficiency, two groups of control experiments were set up here to simulate the preparation of HKUST-1/GF composite through room temperature reaction and solvothermal method.

### Comparative Example 1

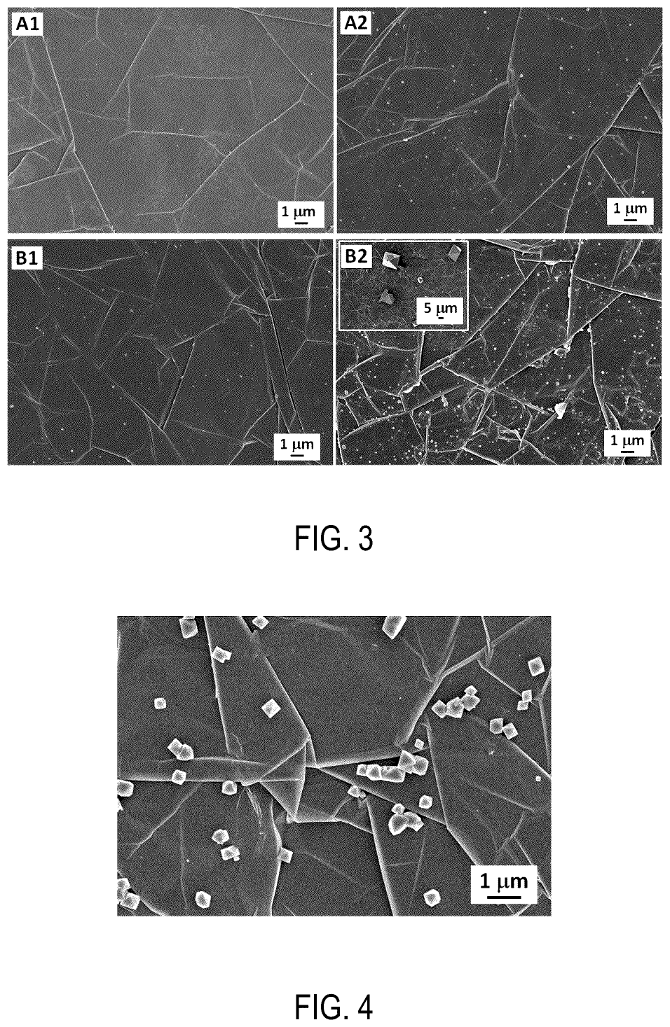

GF was placed statically in the precursor with the same concentration and large volume (400 μL) at room temperature (i.e., no generation of heat), and sealed for 10 and 60 minutes. The structure characterization results of the obtained product are shown in FIG. 3-A. There were almost no crystals on GF at 10 min (see FIG. 3-A1), and a small amount of HKUST-1 nuclei appeared on GF after 60 min of reaction, with a particle size of about 50-150 nm (see FIG. 3-A2), which reflects that it is difficult for HKUST-1 crystallization in a short time under the condition with such precursor concentration and normal temperature.

### Comparative Example 2

The same raw material system of Example 1 was placed in an oven at 120° C. for 10 and 60 minutes (simulating conventional solvothermal preparation), and the characterization results of the obtained HKUST-1/G CF are shown in FIG. 3-B. After 10 min of reaction, the precursor was still a clear and transparent blue solution, and a small amount of HKUST-1 particles were formed on GF (see FIG. 3-B1). After reacting for 60 minutes, a large amount of blue precipitate appeared in the solution. Microscopically (see FIG. 3-B2), a few spherical particles of 100-300 nm, and complete micron-sized octahedron particles was attached on the GF (see small picture in FIG. 3-B2).

On the one hand, the result shows that compared with the reaction at room temperature, high temperature could induce and promote the nucleation and growth of HKUST-1. However, as the heat is conducted from the precursor solution to the surface of GF, the heat mainly acts on the solution to generate free HKUST-1 particles (corresponding to a large number of blue precipitates in the solution), rather than forming HKUST-1/GF in situ growth on GF as expected. In the meantime, the generation of these free HKUST-1 particles consumes a large amount of reaction precursors, which further reduces the reaction efficiency and is not favourable for efficient loading of HKUST-1 on GF.

Comparing the process, product and efficiency of the control groups and the experimental group, the result shows the ultra-high efficiency of this method compared with the conventional preparation methods; not only that the time is short (the preparation time is shortened by at least 4 orders of magnitude (less than 1 s), and the amount of required raw materials may be reduced by 2 orders of magnitude), but also the instruments, devices and operations are simple, and the operation may be carried out in an environment under normal temperature and normal pressure.

### Example 2 HKUST-1/GF-2

HKUST-1/GF-2 was prepared by using electrothermal method to generate local Joule heat in GF. The specific preparation method is as follows:

The preparation device was set up according to the previous steps. The reaction zone is 1 cm wide. 255 mM Cu(NO₃)₂ (dissolved in H₂O), 165 mM trimesic acid (dissolved in DMF) and EtOH were mixed in equal volumes to prepare a precursor solution. 2.35 μL of the precursor were taken and evenly drop-coated in the reaction area of GF. Programming was performed to make the power supply apply a 2.5 A of current for 0.95 s to the GF coated with the precursor, so that the temperature of the GF was up to 240° C., and the reaction time was 0.95 s. After supplying, the film was removed and the reaction zone was kept, the film was washed thoroughly with DMF (1 time) and EtOH (2 times), and dried in an oven at 80° C. to obtain HKUST-1/GF-2.

The characterization results are as follows.

As shown in FIG. 4, the scanning electron micrograph of HKUST-1/GF-2 obtained in Example 2 show that HKUST-1 presents as typical octahedral-shaped particle with a diameter of about 350 nm. Compared with the product prepared in Example 1 (current of 3 A), the number and size of HKUST-1 on the GF were significantly reduced at this time, and the main reason being that current was reduced so Joule heating effect was decreased. The growth of HKUST-1 slows down with the decrease of GF surface temperature, which shows that this method is able to control the nucleation and growth process and rate of nanomaterials such as MOFs through current programming.

### Example 3 HKUST-1/GF-3

HKUST-1/GF-3 was prepared by using electrothermal method to generate local Joule heat in GF. The specific preparation method is as follows:

The preparation device was set up according to the previous steps. The reaction zone is 1 cm wide. 2.55 mM Cu(NO₃)₂ (dissolved in H₂O), 1.65 mM trimesic acid (dissolved in DMF) and EtOH were mixed in equal volumes to prepare a precursor solution. 2.35 μL of the precursor were taken and evenly drop-coated in the reaction area of GF. Programming was performed to make the power supply apply a 3 A of current for 0.95 s to the GF coated with the precursor, so that the temperature of the GF was about 300° C., and the reaction time was 0.95 s. After supplying, the film was removed and the reaction zone was kept, the film was washed thoroughly with DMF (1 time) and EtOH (2 times), and dried in an oven at 80° C. to obtain HKUST-1/GF-3.

The characterization results are as follows.

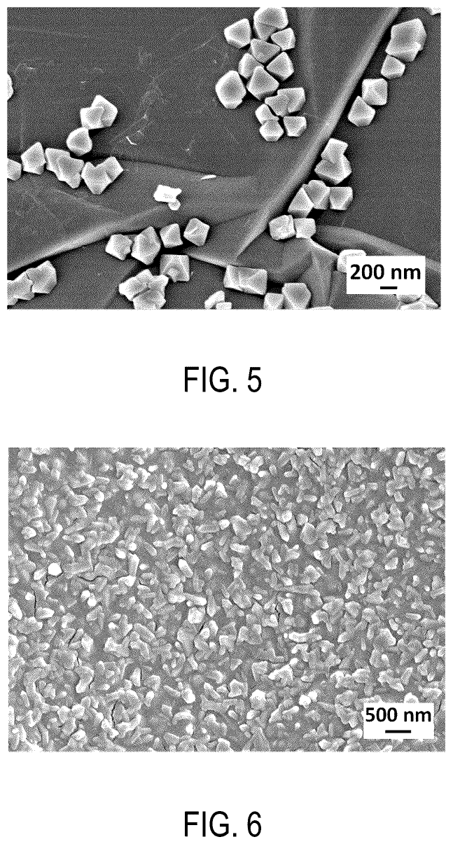

As shown in FIG. 5, the scanning electron micrograph of HKUST-1/GF-3 obtained in Example 3 show that, when the precursor concentration is reduced to the mM level (2 orders of magnitude lower than the conventional concentration (Example 1)), a large number of HKUST-1 octahedral particles are still formed on the GF, which benefits from the synergy between high temperature and evaporation-caused concentration of the precursors. This result shows the superiority of the method of the present disclosure. Compared with conventional methods, the method of the present disclosure significantly improves the utilization rate of reaction raw materials, reducing the usage of reaction raw materials.

### Example 4 MIL-88A/GF

MIL-88A/GF was prepared by using electrothermal method to make GF generate local Joule heat. The specific preparation method is as follows:

The preparation device was set up according to the previous steps. The reaction zone is 1 cm wide. GF was washed, dried and cut into a size of 2 mm×2.25 cm, and placed horizontally in the reaction area. Then both ends of GF were fixed to the glass slide with silver glue, and connected to the positive and negative ends of the power supply through copper foils.

The precursor solution was mixed with 0.04 M FeCl₃ and 0.04 M fumaric acid, and the solvent volume ratio was DMF:EtOH:H₂O═2:1:1. 2 μL of precursor was taken and evenly dropped in the reaction area of GF. Programming was performed to make the power supply apply a 2.75 A of current for 0.95 s to the GF coated with the precursor, so that the temperature of the GF was up to 270° C., and the reaction time was 0.95 s. After supplying, the film was removed and the reaction zone was kept, the film was washed thoroughly with DMF (1 time) and EtOH (2 times), and dried in an oven at 80° C. to obtain MIL-88A/GF.

The characterization results are as follows.

As shown in FIG. 6, the scanning electron micrograph of Example 4 show that MIL-88A in MIL-88A/GF presents as typical spindle-shaped particle, which proves that the university of this method for the preparation of other MOFs composites.

1. A method for preparing a nanomaterial macroscopic composites through substrate heating and solvent evaporation, comprising:
step 1) pre-preparation: setting a substrate, and preparing a reaction precursor solution required for the synthesis of nanomaterials;
step 2) evenly dropping a small volume of the precursor solution on/in the substrate;
step 3) performing a certain heating method to make the substrate generate a heat and transferring the heat to the precursor solution on/in the substrate; after a period of time, terminating the heating of the substrate to finish the synthesis, removing the substrate and cleaning the product, thus obtaining the corresponding nanomaterial macroscopic composites.

2. The method for preparing the nanomaterial macroscopic composites through substrate heating and solvent evaporation according to claim 1, wherein types of materials for the substrate comprises carbon materials, two-dimensional transition metal chalcogenides, metals, metal oxides, or thermally stable organic matters.

3. The method for preparing the nanomaterial macroscopic composites through substrate heating and solvent evaporation according to claim 1, wherein forms of materials for the substrate adopt materials that are able to directly or indirectly generate heat or conduct heat, comprising one-dimensional fibers, two-dimensional films and cloths, or three-dimensional sponges and foams.

4. The method for preparing the nanomaterial macroscopic composites through substrate heating and solvent evaporation according to claim 1, wherein in the step 3), a method of heating the substrate comprises all of the methods that are able to quickly increase the temperature of the substrate material, comprising electrothermal, photothermal, or microwave heating in which the substrate itself directly generates heat, and also comprises placing the substrate on/in a heater for heat transfer.

5. The method for preparing the nanomaterial macroscopic composites through substrate heating and solvent evaporation according to claim 1, wherein main components of the reaction precursor solution comprise a reaction raw material A, a solvent B and a growth regulator C, and the reaction raw material A and the growth regulator C are fully dissolved in the solvent B, and the reaction raw material A, the solvent B and the growth regulator C are mixed uniformly.

6. The method for preparing the nanomaterial macroscopic composites through substrate heating and solvent evaporation according to claim 1, wherein in the reaction precursor solution, a reaction raw material A comprises inorganic metal ions and organics.

7. The method for preparing the nanomaterial macroscopic composites through substrate heating and solvent evaporation according to claim 1, wherein in the reaction precursor solution, a solvent B comprises a mixture of one or more of water, ethanol and N,N-dimethylformamide.

8. The method for preparing the nanomaterial macroscopic composites through substrate heating and solvent evaporation according to claim 1, wherein types of the nanomaterials in the nanomaterial macroscopic composites comprise all of materials prepared by hydrothermal/solvothermal methods, including metal organic frameworks, covalent organic frameworks, metals and oxides thereof.

9. The method for preparing the nanomaterial macroscopic composites through substrate heating and solvent evaporation according to claim 1, wherein in the step 3), the heat is generated at a temperature of 60-300° C., a reaction time is 0.01-15 s; a cleaning solvent is N,N-dimethylformamide, water, ethanol, or acetone; a drying temperature is 60-150° C., and a drying time is 6-24 hours.

10. Use of the nanomaterial macroscopic composites prepared by the method according to claim 1, comprising its use in water purification, gas separation, catalysis, sensing and a combination thereof.
